(19) United States
(12) Patent Application Publication
(10) Pub. No.: US 2019/0200618 A1
(43) Pub. Date: Jul. 4, 2019

(54) Composite Coatings of Oxidized and/or Phosphorous Copper

(71) Applicant: Meto & Co., Balaruc-Les-Bains (FR)

(72) Inventor: Stephane Penari, Balaruc-Les-Bains (FR)

(21) Appl. No.: 16/272,221

(22) Filed: Feb. 11, 2019

Related U.S. Application Data
(62) Division of application No. 14/905,300, filed on Jan. 15, 2016, now abandoned.

(30) Foreign Application Priority Data
Jul. 18, 2013 (FR) 1357099
Mar. 28, 2014 (FR) 1400766

(51) Int. Cl. A01N 59/20; C09D 5/16; C01G 3/00; C09D 5/10; C09D 5/08; C09D 1/00; A01N 25/12; C09D 5/14

(52) U.S. Cl. CPC A01N 59/20; C09D 5/1618; C01G 3/00; C09D 5/10; C08K 3/22; C09D 1/00; A01N 25/12; C09D 5/14; C09D 5/082

(57) ABSTRACT

The present invention relates to a synthetic coating containing oxidized and/or phosphorous copper, the method for obtaining the coating and the uses of said coating. The present invention further relates to an oxidized and/or phosphorous copper powder making it possible to obtain the coating of interest, the method for manufacturing said coating and its uses.

The object of the present invention relates to a synthetic coating containing oxidized and/or phosphorized copper, the method for obtaining the coating, and uses of said coating. Moreover, the present invention relates to an oxidized and/or phosphorized copper powder for obtaining the coating of interest, the method for manufacturing same and uses thereof.

### INTRODUCTION

At the dawn of the 1980s, a novel technique appeared which revolutionized the way in which the world works metal.

This technique, which consists schematically in combining metal and binder, makes it possible to quickly coat almost any support, whatever the form or nature (laminates, melamines, wood, plastics, plaster, fiberglass, ceramics, concrete, foams, porcelain, glass and metal), while following surface details perfectly.

This true composite material is available today in several varieties, thus solving the numerous problems associated with the use of solid metal.

Thus, objects that would be too heavy or too expensive to make of solid metal, or would involve overly burdensome techniques for creating fine details, can be metallized very quickly at a fraction of the weight and price.

Thus, cold metallization technology is applied by means of conventional paint gun equipment. Metal composites are sprayed cold by means of a high volume/low pressure (HVLP) gun with suitable nozzles.

Each composite is formed of micronized aggregates of metal, hybrid polymer binder and catalyst. The metal and the polymer binder interact in a chemical reaction which creates an extremely stable and homogeneous composite. After catalysis, the polymer and the metal bind chemically by producing very strong adhesion between the composite thus formed and the support.

The composite applies to “red” as well as to “gray” metals and alloys: copper (99% pure copper compound) and alloys thereof such as bronze (compound the great majority of which is copper alloyed with tin), brass (alloy mainly of copper and zinc), nickel-silver (alloy of copper, nickel and zinc); or iron (pure iron compound), aluminum (pure aluminum compound), X-metal (alloy of equal parts copper and tin), stainless steel (alloy mainly of iron, chromium and nickel), gunmetal (alloy of copper, tin and silver), tin or a compound of tin and silver, etc.

New metals are added regularly to this range.

Catalyzed composite metals can be sanded, polished, brushed, acidified, oxidized, etched (if the thickness permits), varnished and treated exactly in the same way as solid metal.

This method enables the application of a thin layer of composite on the support. There is no limitation as for the thickness. However, a good economic compromise is around 0.07 to 0.015 mm in thickness, which can be obtained in a single coat.

These composites can be applied to flexible materials. Moreover, the composite layer does not conduct electricity and does not corrode the support, which distinguishes it from metal.

Recently, the Applicant showed that copper composites are very well suited for antifouling-type coatings in the boating industry (see, for example, the article published in “Motor Boat Magazine”, No. 282 June 2013, pp. 133-137).

The products developed by the Applicant further enable a given craft to reduce fuel consumption and/or to increase speed.

On the other hand, the Applicant noted that the color of such compositions varied over time due to oxidation of the copper (the color “verdigris”).

This requires the user to reapply the coating more often or quite simply to choose another copper-free antifouling agent. Thus, the Applicant first developed an “anthracite” composition (not forming part of the present invention) for camouflaging the copper-oxide color, but it was found unsuitable due to questions of a practical nature (requiring systematic sanding after application).

Several solutions were then found by the Applicant in order to obtain a satisfactory color that endures over time.

A first solution for stabilizing the color of the coating over time was to use CuP₈ powder in the composite used in the coating. CuP₈ is commonly used in welding applications. However, when CuP₈ powder is used in a composite according to the present invention, the coatings obtained exhibit in addition exceptional aesthetic features (anthracite color) that endure over time. This is particularly surprising because CuP₈ in the powder state is gray in color and it is only when it is incorporated into the composite that it has this anthracite black color that also does not show the esthetically harmful effects of its surface oxidation.

A supplementary solution found by the Applicant was to oxidize the micronized aggregates of copper before incorporating them into the coating. The coating obtained retains its antifouling properties and its properties of reducing the fuel consumption and/or increase the speed of a given craft, while having suitable esthetic features. It is thus surprising that by varying the oxidation of the copper or the nature of the powder (phosphorized copper such as CuP₈), the coating keeps its nautical properties, while the opposite might have been expected: traditional copper coatings must be replaced after one year/season of use when the copper (i.e., the active agent) is oxidized/modified.

Moreover, in the tests performed, oxidizing the copper (and/or alloys thereof) before incorporating same into the coating produces a deep black (rather aesthetic) coating that endures over time and thus solves the initial technical problem of the color of the composite (pigmentation). However, the Applicant realized that in order to be able to produce such composites, the oxidized and/or phosphorized copper powder (such as CuP₈) could not be too fine, or else the composite could not be made. Thus, the powders according to the invention result from a development in terms of the choice of their chemical nature and their particle size.

Furthermore, phosphorized copper powders (such as CuP₈) can also be oxidized in the same manner, which very slightly changes the final color of the composite (the powder grains being oxidized to the core and not superficially) but allows it to gain the physical, chemical and biological properties of oxidized powders.

Indeed, the Applicant realized that the antimicrobial properties of coatings thus produced seem to have been exacerbated in comparison with prior copper coatings (not oxidized, for example), enabling an even broader application. This unexpected additional effect complements the initial invention. However, in order to have such antimicrobial properties, the Applicant realized that a minimum amount of copper was needed in the composite.

Of course, copper is known to have advantageous antimicrobial properties, as has been reported by A. L. Casey et al. in “Role of copper in reducing hospital environment contamination”; J Hosp Infect (2009), doi:10.1016/j.jhin.2009.08.18, but the oxidized copper coatings of the present invention have even better microbial lysis kinetics.

Moreover, from a technical point of view it is not always possible to make all objects, in particular for hospital use, of solid copper. Added to that, the financial market for metals varies, which impacts the economic feasibility of such objects (of solid copper) over time.

Thus, the object of the present invention makes it possible to easily obtain the object biocides, which can be incorporated into everyday life or into specialized environments such as the boating or hospital sectors, for example while having an acceptable aesthetic appearance (pigmentation).

### SUMMARY OF THE INVENTION

The object of the present invention relates to a composition of oxidized and/or phosphorized copper powder, preferably in the form of CuP₈, characterized in that said powder:
contains at least 60% by mass of copper,
contains not more than 70% by mass of grains the diameter of which is less than 45 μm at most.

The object of the present invention thus relates to a method for manufacturing a composition as defined at present, characterized in that copper is oxidized at a temperature equal to or greater than 500° C. in the presence of oxygen and/or a source of oxygen, preferably in the presence of magnesium or phosphorus.

The object of the present invention further relates to the use of a composition as defined at present as a biocide, preferably in order to prevent nosocomial diseases or as an antifouling agent.

The object of the present invention further relates to the use of a composition as defined at present in order to slow or prevent biocorrosion of a substrate, preferably by coating said substrate with said composition.

The object of the present invention further relates to the use of a composition as defined at present in order to pigment a composite.

The object of the present invention further relates to a composite characterized in that it comprises a powder composition as defined at present, a binding agent and optionally a curing catalyst.

The object of the present invention thus relates to a method for manufacturing the composite as defined at present characterized in that the powder composition is mixed at room temperature with the binder in the liquid state, then a curing catalyst is added if need be.

The object of the present invention further relates to the use of a composite as defined at present, for coating a substrate or molding a substrate.

The object of the present invention thus relates to a method for manufacturing a surface coating characterized in that the composite as defined at present is sprayed on the surface of a substrate, or in that the substrate is dipped in the composite in the liquid state.

The object of the present invention further relates to a surface coating obtainable by the above method.

The object of the present invention further relates to the use of a surface coating as defined at present as a biocide, preferably in order to prevent biocorrosion, for example on the bottom of a boat.

### DEFINITIONS

Antifouling Paint

Antifouling paint is paint containing biocides designed to prevent aquatic organisms from attaching to the hull of a ship or to other submerged objects.

Powder

Generally, powder is a fractionated state of material. It is thus a plurality of units (or pieces/granules) of solids of size generally less than one-tenth of a millimeter (100 μm), which together constitute a “collection.” The physical properties of a powder are characterized by its particle size.

Oxidized Copper Powder

By “oxidized copper powder” is meant, according to the present invention, first, that the powder has the particle size features defined at present (allowing it to be incorporated into a binder) and, second, that the powder has an oxidized copper content greater than or equal to 5% by mass of the total mass of copper in the powder, preferably greater than or equal to 10%, 20%, 30%, 40%, 50%, 60%, 70%, 80%, 90%, 95%, 99% or 100% by mass of the total mass of copper in the powder.

Phosphorized Copper Powder

By “phosphorized copper powder” is meant, according to the present invention, first, that the powder has the particle size features defined at present (allowing it to be incorporated into a binder) and, second, that the powder has a phosphorus content between 2% and 16% by mass, preferably 8%. In a preferred manner, the phosphorized copper powder consists of an alloy of copper and phosphorus, preferably CuP₈, preferably with a copper:phosphorus content expressed as a percentage by mass equal to or greater than 84%:16%, 85%:15%, 86%:14%, 87%:13%, 88%:12%, 89%:11%, 90%:10%, 91%:9%, 92%:8%, 93%:7%, 94%:6%, 95%:5%, 96%:4%, 97%:3%, 98%:2%, 99%:1%, more preferably greater than or equal to 92%:8%. In a preferred manner, the powder comprising phosphorized copper comprises as the majority element in its composition CuP₈, or consists of CuP₈, which can, for example, be included in a proportion equal to or greater than 50%, 60%, 70%, 80%, 90%, 95%, 99% by mass of the total mass of powder.

Particle Size

Particle size is generally the study of the statistical distribution of the sizes of a plurality of solid units (or pieces/granules) of natural or fractionated material (i.e., a collection). Particle size analysis is the set of operations used to determine the size distribution of the component elements of a powder. A particle size distribution is a tabular or graphical representation of the experimental results of a particle size analysis.

Biocide

The definition of the term “biocide” according to the present invention agrees with that of the Directive 98/8/EC of the European Parliament and of the Council of 16 Feb. 1998 concerning the placing of biocidal products on the market (Official Journal of the European Communities, L 123 of 24 Apr. 1998) which defines them as being “Active substances and preparations containing one or more active substances, put up in the form in which they are supplied to the user, intended to destroy, deter, render harmless, prevent the action of, or otherwise exert a controlling effect on any harmful organism by chemical or biological means”.

Nosocomial Diseases

The term “nosocomial” comes from the Greek nosos, disease, and komein, to care for, which form the word nosokomeion, hospital. Nosocomial diseases are caused by a nosocomial infection, i.e., an infection contracted in a healthcare facility. An infection is called nosocomial or hospital-acquired if it is absent when the patient is admitted to the hospital and it develops at least 48 hours after admission. This period helps distinguish a nosocomial infection from a community-acquired infection. The 48-hour period is extended up to 30 days for surgical infections and up to one year for implanted prosthetic material. In other words, any infection occurring at a surgical scar within one year following the operation, even if the patient has been discharged from the hospital, can be regarded as nosocomial.

For example, the object of the present invention can be active and prevent pathologies due to Gram-positive bacteria, Gram-negative bacteria, anaerobic bacteria, viruses or even fungi.

Examples of Gram-positive bacteria potentially sensitive to products according to the present invention, in particular drug-resistant or multidrug-resistant Gram-positive bacteria, can be selected from the following, among others: Staphylococcus, in particular Staphylococcus aureus, Enterococcus, in particular Enterococcus faecalis and Enterococcus cloacae, and/or Propionibacterium, in particular Propionibacterium acnes.

Examples of Gram-negative bacteria potentially sensitive to products according to the present invention, in particular drug-resistant or multidrug-resistant Gram-negative bacteria, can be selected from the following, among others: Escherichia, in particular Escherichia coli, Pseudomonas, in particular Pseudomonas aeruginosa, Acinetobacter, in particular Acinetobacter baumannii, Serratia, in particular Serratia marcescens, Citrobacter, in particular Citrobacter freundii, Klebsiella, in particular Klebsiella pneumonia, and/or Enterobacter, in particular Enterobacter aerogenes.

Examples of anaerobic bacteria potentially sensitive to products according to the present invention, in particular drug-resistant or multidrug-resistant anaerobic bacteria, can be selected from the following, among others: Bacteroides, in particular B. fragilis and B. thetaiotaomicron; Eggerthella, in particular E. lenta; Peptostreptococcus, in particular P. micros, P. spp., and P. anaerobius; Clostridium, in particular C. perfringens and C. difficile; and/or Micromonas.

Examples of fungi potentially sensitive to products according to the present invention, in particular drug-resistant or multidrug-resistant fungi, can be selected from the following, among others: keratinous or epidermal fungi, dermal, in particular Candida, Trichophyton, Malassezia and Microsporum, systemic, in particular in non-opportunistic diseases, more particularly associated with Blastomyces, Coccidioides, and in opportunistic diseases due to Aspergillus, Candida albicans, Cryptococcus, for example.

Examples of viruses potentially sensitive to products according to the present invention are DNA viruses and RNA viruses, enveloped or naked, such as flu (influenza) viruses, hepatitis viruses, AIDS, colds, hemorrhagic fevers, etc.

Biocorrosion

The term “biocorrosion” according to the present invention relates to corrosion of materials directly due to or following the action of living organisms. These living organisms can be microscopic or macroscopic, unicellular or multicellular, such as bacteria, algae, fungi, molluscs, etc.

Binding Agent

A binding agent according to the present invention relates to a product that binds the molecules of one element to another element, during the fusion (generally cold) of the materials. For example, in the present case, a binding agent will enable the agglomeration of the powder particles in a fixed matrix, which can be polymeric.

Curing Catalyst

The curing catalyst enables the acceleration, even the feasibility, of polymerization in a matrix, which can be hard or flexible. The catalyst can be replaced with heat treatment. The polymer is often prepared by crosslinking two ingredients, of which one is typically a “resin,” reacting under the action of heat in the presence of reagents (polymerization catalyst and accelerator). The stable three-dimensional structure (network) typically formed has thermomechanical and chemical resistance.

Composite

A composite is a combination of two materials of different nature. In the present invention, it is a matter of combining particles of a metal powder in a fixed organic or inorganic matrix, which nevertheless, if need be, allows a certain mechanical flexibility. The composite can be used to mold various and varied objects and is not limited only to the production of a surface coating.

Room Temperature

Room temperature is generally accepted as being between 15 and 30 C, preferably between 20 and 25 C.

Coating

The purpose of a coating (also called a “thin layer” when its thickness is between a few microns and a few hundred microns) is to improve the surface properties of an object. For example, and in a general manner, coatings can be used to preserve or improve the appearance, adhesion and corrosion resistance; provide specific wettability properties; or adjust the surface properties of a given object in terms of the mechanical stresses and the various elements of the external environment (ultraviolet rays, water, oxidation (corrosion), temperature, mold and mildew, etc.). The surface coating of the present invention can be used without restriction in various thicknesses and is generally applied like resins already on the market. Moreover, the composite according to the present invention can be sprayed in a thin layer of a few microns.

Thus the coating of the present invention can have a thickness varying from a few microns to a few centimeters. The thickness of the coating is advantageously between 10 μm and 15 cm, more advantageously between 50 μm and 5 cm, even more advantageously between 100 μm and 1 cm, still more advantageously between 150 μm and 1 mm, such as 200 μm, or even between 500 μm and 1 mm.

Thus any physical or physicochemical technique applicable in the present case and known to the skilled person can be used in the formation of the coating. An additional step could consist in the use of laser technology, or in the use of strong magnetic and/or electric fields, the piezoelectric effect, ultrasound, the application of electrospray, electrochemistry, microwaves, or simple heat treatment, for example.

The coating obtained in contact with the free surface of the substrate according to the method of the present invention can have a substantially constant thickness.

Molding

The composites according to the present invention can in addition be used to mold objects. The molding technique consists in taking an impression that is then used as a mold. Inside this mold will be placed a material that enables the printing or the production of several copies of a model. According to the present invention, molding thus consists in placing a composite in a mold whose shape it will take and then removing it therefrom. The object arising from this molding can be hollow or filled with the composite or another material, such as polymer without metal powder, for example.

Surface of a Substrate

According to the method of the present invention, which consists in depositing a coating on a substrate, prior to the deposition of said coating, advantageously, the surface of the substrate to be coated is made adhesive. Advantageously, said surface is made adhesive by functionalization, for example by adsorption of PEI, by surface nucleation or by mineralization of said substrate.

Substrate

As explained above, the term “substrate” refers to a solid support onto which will be deposited at least one layer of coating of the invention. This support can be of any nature, i.e., natural or synthetic, organic, mineral or inorganic, crystalline, polycrystalline and/or amorphous.

In a particular embodiment, in the method according to the invention, the substrate is the hull of a craft, such as a boat, the hydrofoils of a boat, external elements of aircraft or rockets or any support used in sports involving sliding or gliding, such as the bottom of a sail board, surfing kite, water ski, wakeboard, surfboard, Alpine ski, snowboard, paddle board, jet ski, canoe, kayak, etc. Indeed, the coating of the present invention makes it possible to limit the friction phenomena associated with fluids.

In another embodiment, the substrate can be any hospital equipment, whether specialized equipment (analytical and surgical equipment, wheelchairs, crutches, etc.) or more common items (door handles, switches, adjustable trays, toilet lids, shower grab-bars, taps, etc.). Of course, this equipment can also be found more commonly outside a hospital setting, in particular for people whose immunity is weak, weakened or likely to become weak (due to medical treatment that effects immunity, for example).

Fluid

By “fluid” is meant according to the present invention any substance that deforms continuously under shear stress applied to it. Thus, a fluid can be defined as being a substance the molecules of which have little adhesion and slide past each other (liquids) or move independently of each other (gases), such that this substance takes the shape of the space that contains it.

Spraying/Sprayed

The term “spraying” according to the present invention relates to the production of a droplet cloud, i.e., containing micron- or nanometer-size droplets suspended in the gas containing them, and that optionally carries them, or the space containing them (in the case of an ultrasonic spray nozzle). A “nozzle” is a device that enables such a spraying.

The droplets can touch each other within the cloud they form. These collisions can cause droplet coalescence.

It is also possible to use a gas such as nitrogen or an inert gas such as argon in carrying out the method, whether as the carrier gas in spraying, or quite simply within the spraying enclosure, or both. It is also possible to deposit the coatings of the present invention by means of ultrasonic nozzles, for example. The present invention can be carried out under ambient atmosphere. It is of course also possible to use an oxidizing, reducing or reactive gas atmosphere in the implementation of the method of the present invention.

Thus, according to the method of the present invention, the interaction between the reaction partners is advantageously controlled determining at least one of the following setting parameters:
concentration of the reaction partners in the liquid(s) and viscosity of the spray liquid(s) containing the reaction partners;
composition and nature of the solvent present in the sprayed liquid(s);
temperature of the sprayed liquid(s);
size, density, speed and polydispersity of the droplets as a function of the geometry and nature of the spray nozzles;
variation of the angles at the vertex of the dispersion cones of the spray jet(s);
distance between the nozzles and the surface of the substrate to be coated when there are several nozzles;
incline of said surface relative to the principal axis of the spray jet(s);
flow rate of the spray jet(s);
flow rate of the carrier gas used for the spraying(s);
nature, temperature, flow rate and/or pressure of the carrier gas used for the spraying(s);
nature of the solid support.

Spraying according to the present invention can be carried out continuously or can be interrupted, without harming the integrity of the coating obtained at the end of the method. The coating is applied to the substrate while controlling the spray parameters, for example the viscosity of the composite mixture in a sprayed liquid state, the curing time (for example by the amount of catalyst, temperature management), the type of nozzle, the air flow, etc. The same coating thicknesses are obtained whether said coatings are produced in a single step or in several steps, the important issue being that the cumulative spraying time is constant, even if the coating cures after each step. This is true for organic as well as inorganic polymer-based coatings.

Spray Control

The advantage of spraying in the present invention rests on the use of small droplets and a thin liquid film that solidifies to produce a coating the thickness of which can be easily controlled (curing time a direct function of the amount of catalyst, for example, or of the dilution).

Moreover, it is possible to control the overlap area during spraying according to the method of the invention by interposing a screen provided with an opening for selecting the central part of the spray jet(s) and preventing contamination of the surface by the edges of the jet(s).

The screen can be made of any type of material in any possible shape.

It can be advantageous during spraying according to the method of the invention to add an additional screen, between the nozzle(s) and the crossover point of the spray jet(s), provided with at least one opening passing alternately in front of the spray jets in order to control the collisions and interactions of the sprayed droplets (FIG. 1).

Advantageously, the opening of the additional screen, between the nozzle(s) and the crossover point of the spray jets, is calibrated.

The screen can be intercalated between the nozzle(s) and the crossover point of the spray jets by any movement whatever.

Advantageously, the additional screen comes in between the nozzle(s) and the crossover point of the spray jets by a rotating movement. The screen is thus referred to as rotary in this particular embodiment.

Advantageously, the additional screen comes in between the nozzle(s) and the crossover point of the spray jets by a lateral linear movement on a system of sliding channels, for example. The screen is thus referred to as linear in this particular embodiment.

It can be advantageous during spraying according to the method of the invention to interpose an additional rotary screen between the nozzle(s) and the first crossover point of the spray jets when there are several jets/nozzles.

Positioning the Substrate

Said substrate, onto which the coating can be sprayed, can be positioned and oriented in any manner so as to produce a more or less thin layer of composite. In a particular embodiment, said substrate can be positioned vertically so that excess reaction liquid and/or solvent(s) flow as spraying proceeds. Said substrate can also be inclined to a greater or lesser degree from the vertical. In a particular embodiment, said substrate can be positioned horizontally so that the distribution of the coating, which cures more or less slowly, is homogeneous.

The variations of these inclines depend on spray factors and/or the formation of the coating.

Advantageously, said substrate is inclined slightly relative to the vertical axis for fast coating formation reactions or, optionally, those requiring no further treatment, i.e., at an angle of between 0° and 45° from the vertical axis.

Advantageously, said substrate is inclined slightly relative to the horizontal axis for slow reactions or those requiring further treatment (by means of laser technology, for example), i.e., at an angle of between 0° and 45° from the horizontal axis.

Control of Air Flow: Control of Coating Thickness

The thickness of the coating formed can be directly related to the air flow applied. Thus, according to the method of the invention, a flow of air—intended to control the thickness of the coating formed in contact with the free surface of the substrate—is applied. The homogeneity of the thickness of the coating is also influenced by the flow of liquid, the nature of the substrate, the viscosity of the liquid (concentration) and the positioning of the nozzle(s).

Sprayers

Various sprayers can be used in the present invention, such as for example:
a single-component sprayer, for example spraying a single liquid under pressure,
a multiple-component sprayer, for example a chemical compound in solution in solvent medium,
a nebulizer in which a gas and a liquid are sprayed,
a piezoelectric sprayer,
an atomizer, or
an ultrasonic sprayer.

The quality of the spraying and thus of the coating obtained can also be optimized by the positioning of the nozzle(s) of the sprayer(s).

Thus, advantageously according to the method of the present invention, the nozzles are disposed such that the spray jets arrive at the substrate surface in a substantially orthogonal direction in relation to the latter.

Bottom

By “bottom” is meant according to the present invention the submerged part of the hull of a ship, or any other craft, or the part of the substrate (such as a ski, for example) in direct contact with the friction-causing liquid, solid or intermediate element (such as snow).

Oxidation to the Core

By “oxidation to the core” is meant, according to the present invention, that the grains of oxidized copper powder are oxidized both on the surface and in the center of the grains of which said powder is comprised. The oxidation ratio can nevertheless vary in a straight line from the surface to the center (i.e., the center of gravity) of the grain. Typically, the surface of the grain is more oxidized than the center due to the former's greater entropy. Advantageously, the center has an oxidation ratio that is 50% by mass lower than that of the surface, more advantageously still the center has an oxidation ratio that is 25% by mass lower than that of the surface, even more advantageously the center has an oxidation ratio that is 10% by mass lower than that of the surface, more advantageously than that the center has an oxidation ratio that is 5% by mass lower than that of the surface, in the most advantageous manner the center has an oxidation ratio that is identical to that of the surface.

Oxidation Ratio

Generally, oxidation involves a loss of electrons from the oxidized entity. In the present invention, this is expressed as the reaction of oxygen with the copper in the powder. For example, if the powder initially contains only copper, the “oxidation ratio” according to the present invention then refers to the initial mass amount of copper in the zero oxidation state (“Cu⁰”) that is oxidized to CuO, i.e., the copper is in the +2 oxidation state. Generally, oxidation ratio thus refers to the amount of copper that is oxidized and thus represents a ratio of amounts (mass, mole) of the copper that is engaged in the oxidation reaction.

Generally, according to the present invention, the amount of copper being preponderant, for the sake of convenience it is referred to by approximation to mass ratios. Strictly speaking, they would be molar ratios.

Pigment

In the context of the present invention, by “pigment” is meant an insoluble coloring substance within the matrix of the material containing it. Preferably the pigment is a coloring substance for composites, i.e., for coloring the mass of a composite comprising a binding agent and optionally a curing catalyst. Preferably the pigments of the present invention make it possible to obtain coatings/composites in the colors black, anthracite, or black with brown highlights, or brown dark according to the nature and concentration of the pigment (powder).

### DETAILED DESCRIPTION

More particularly, the object of the present invention relates to a composition of oxidized and/or phosphorized copper powder as defined above wherein the copper mass is greater than or equal to 65%, advantageously greater than 70%, more advantageously greater than 75%, more advantageously still greater than 80%, even more advantageously greater than 85%, even more advantageously greater than 90%, even more advantageously greater than 95%, even more advantageously greater than 97%, even more advantageously greater than 98%, even more advantageously greater than 99%, even more advantageously greater than 99.5%, even more advantageously greater than 99.9% by mass relative to the total mass of the powder composition.

The amount of copper in the mixture will directly influence the biocidal activity of the final coating/composite.

Another factor that should be taken into account is the particle size of the powder. Indeed, completely independently of the copper ratio the oxidized and/or phosphorized copper powder contains, the particle size of the oxidized and/or phosphorized copper powder according to the present invention will be the decisive factor in order to produce the coating/composite with the binding agent. Indeed, if the powder is too fine, unlike what would have been expected before the creation of the present invention, the composite does not form correctly and has unacceptable physicochemical properties (hardness, friability, flexibility, etc.). Thus there seems to be a threshold at around 70% by mass of grains of the oxidized and/or phosphorized copper powder composition as defined above, the diameter of which is less than 45 μm at most, which should not be crossed in order to produce the final coating/composite.

In a particular embodiment, the oxidized and/or phosphorized copper powder contains not more than 65% by mass of grains the diameter of which is less than 45 μm at most.

In a particular embodiment, the oxidized and/or phosphorized copper powder contains not more than 60% by mass of grains the diameter of which is less than 45 μm at most.

In a particular embodiment, the oxidized and/or phosphorized copper powder contains not more than 58.8% by mass of grains the diameter of which is less than 45 μm at most.

In a particular embodiment, the oxidized and/or phosphorized copper powder contains not more than 55% by mass of grains the diameter of which is less than 45 μm at most.

In a particular embodiment, the oxidized and/or phosphorized copper powder contains not more than 50% by mass of grains the diameter of which is less than 45 μm at most.

In a particular embodiment, the oxidized and/or phosphorized copper powder contains not more than 45% by mass of grains the diameter of which is less than 45 μm at most.

In a particular embodiment, the oxidized and/or phosphorized copper powder contains not more than 40% by mass of grains the diameter of which is less than 45 μm at most.

In a particular embodiment, the oxidized and/or phosphorized copper powder contains not more than 35% by mass of grains the diameter of which is less than 45 μm at most.

In a particular embodiment, the oxidized and/or phosphorized copper powder contains not more than 25% by mass of grains the diameter of which is less than 45 μm at most.

In a particular embodiment, the oxidized and/or phosphorized copper powder contains not more than 20% by mass of grains the diameter of which is less than 45 μm at most.

In a particular embodiment, the oxidized and/or phosphorized copper powder contains not more than 15% by mass of grains the diameter of which is less than 45 μm at most.

In a particular embodiment, the oxidized and/or phosphorized copper powder contains not more than 10% by mass of grains the diameter of which is less than 45 μm at most.

In a particular embodiment, the oxidized and/or phosphorized copper powder contains not more than 5% by mass of grains the diameter of which is less than 45 μm at most.

In a particular embodiment, the oxidized and/or phosphorized copper powder contains not more than 2% by mass of grains the diameter of which is less than 45 μm at most.

In a particular embodiment, the oxidized and/or phosphorized copper powder contains not more than 1% by mass of grains the diameter of which is less than 45 μm at most.

In a particular embodiment, the oxidized and/or phosphorized copper powder does not contain grains the diameter of which is less than 45 μm at most.

These particular embodiments, wherein the maximum amount of grains the diameter of which is less than 45 μm is defined, can be individually combined with the following ranges of minimum amounts of grains, the diameter of which is less than 63 μm at most, in the oxidized and/or phosphorized copper powder composition according to the present invention.

Advantageously, the oxidized and/or phosphorized copper powder contains at least 1% by mass of grains the diameter of which is less than 63 μm at most.

More advantageously, the oxidized and/or phosphorized copper powder contains at least 2% by mass of grains the diameter of which is less than 63 μm at most.

Even more advantageously, the oxidized and/or phosphorized copper powder contains at least 5% by mass of grains the diameter of which is less than 63 μm at most.

Even more advantageously, the oxidized and/or phosphorized copper powder contains at least 10% by mass of grains the diameter of which is less than 63 μm at most.

Even more advantageously, the oxidized and/or phosphorized copper powder contains at least 15% by mass of grains the diameter of which is less than 63 μm at most.

Even more advantageously, the oxidized and/or phosphorized copper powder contains at least 20% by mass of grains the diameter of which is less than 63 μm at most.

Even more advantageously, the oxidized and/or phosphorized copper powder contains at least 25% by mass of grains the diameter of which is less than 63 μm at most.

Even more advantageously, the oxidized and/or phosphorized copper powder contains at least 30% by mass of grains the diameter of which is less than 63 μm at most.

Even more advantageously, the oxidized and/or phosphorized copper powder contains at least 35% by mass of grains the diameter of which is less than 63 μm at most.

Even more advantageously, the oxidized and/or phosphorized copper powder contains at least 40% by mass of grains the diameter of which is less than 63 μm at most.

Even more advantageously, the oxidized and/or phosphorized copper powder contains at least 45% by mass of grains the diameter of which is less than 63 μm at most.

Even more advantageously, the oxidized and/or phosphorized copper powder contains at least 50% by mass of grains the diameter of which is less than 63 μm at most.

Even more advantageously, the oxidized and/or phosphorized copper powder contains at least 55% by mass of grains the diameter of which is less than 63 μm at most.

Even more advantageously, the oxidized and/or phosphorized copper powder contains at least 60% by mass of grains the diameter of which is less than 63 μm at most.

Even more advantageously, the oxidized and/or phosphorized copper powder contains at least 65% by mass of grains the diameter of which is less than 63 μm at most.

Even more advantageously, the oxidized and/or phosphorized copper powder contains at least 70% by mass of grains the diameter of which is less than 63 μm at most.

Even more advantageously, the oxidized and/or phosphorized copper powder contains at least 75% by mass of grains the diameter of which is less than 63 μm at most.

Even more advantageously, the oxidized and/or phosphorized copper powder contains at least 80% by mass of grains the diameter of which is less than 63 μm at most.

Even more advantageously, the oxidized and/or phosphorized copper powder contains at least 85% by mass of grains the diameter of which is less than 63 μm at most.

Even more advantageously, the oxidized and/or phosphorized copper powder contains at least 90% by mass of grains the diameter of which is less than 63 μm at most.

Even more advantageously, the oxidized and/or phosphorized copper powder contains at least 95% by mass of grains the diameter of which is less than 63 μm at most.

Even more advantageously, the oxidized and/or phosphorized copper powder contains at least 97% by mass of grains the diameter of which is less than 63 μm at most.

Even more advantageously, the oxidized and/or phosphorized copper powder contains at least 98% by mass of grains the diameter of which is less than 63 μm at most.

Even more advantageously, the oxidized and/or phosphorized copper powder contains at least 99% by mass of grains the diameter of which is less than 63 μm at most.

Even more advantageously, the oxidized and/or phosphorized copper powder contains at least 99.5% by mass of grains the diameter of which is less than 63 μm at most.

For example, according to an embodiment of the present invention, the oxidized and/or phosphorized copper powder contains not more than 70% by mass of grains the diameter of which is less than 45 μm at most and at least 1%, 2%, 5%, 10%, 15%, 20%, 25%, 30%, 35% or 40% by mass of grains the diameter of which is less than 63 μm at most.

For example, according to an embodiment of the present invention, the oxidized and/or phosphorized copper powder contains not more than 65% by mass of grains the diameter of which is less than 45 μm at most and at least 1%, 2%, 5%, 10%, 15%, 20%, 25%, 30%, 35% or 40% by mass of grains the diameter of which is less than 63 μm at most.

For example, according to an embodiment of the present invention, the oxidized and/or phosphorized copper powder contains not more than 60% by mass of grains the diameter of which is less than 45 μm at most and at least 1%, 2%, 5%, 10%, 15%, 20%, 25%, 30%, 35% or 40% by mass of grains the diameter of which is less than 63 μm at most.

For example, according to an embodiment of the present invention, the oxidized and/or phosphorized copper powder contains not more than 58.8% by mass of grains the diameter of which is less than 45 μm at most and at least 1%, 2%, 5%, 10%, 15%, 20%, 25%, 30%, 35% or 40% by mass of grains the diameter of which is less than 45 μm at most.

For example, according to an embodiment of the present invention, the oxidized and/or phosphorized copper powder contains not more than 55% by mass of grains the diameter of which is less than 45 μm at most and at least 1%, 2%, 5%, 10%, 15%, 20%, 25%, 30%, 35%, 40% or 45% by mass of grains the diameter of which is less than 45 μm at most.

For example, according to an embodiment of the present invention, the oxidized and/or phosphorized copper powder contains not more than 50% by mass of grains the diameter of which is less than 45 μm at most and at least 1%, 2%, 5%, 10%, 15%, 20%, 25%, 30%, 35%, 40%, 45% or 50% by mass of grains the diameter of which is less than 45 μm at most.

For example, according to an embodiment of the present invention, the oxidized and/or phosphorized copper powder contains not more than 45% by mass of grains the diameter of which is less than 45 μm at most and at least 1%, 2%, 5%, 10%, 15%, 20%, 25%, 30%, 35%, 40%, 45%, 50% or 55% by mass of grains the diameter of which is less than 45 μm at most.

For example, according to an embodiment of the present invention, the oxidized and/or phosphorized copper powder contains not more than 40% by mass of grains the diameter of which is less than 45 μm at most and at least 1%, 2%, 5%, 10%, 15%, 20%, 25%, 30%, 35%, 40%, 45%, 50%, 55% or 60% by mass of grains the diameter of which is less than 45 μm at most.

For example, according to an embodiment of the present invention, the oxidized and/or phosphorized copper powder contains not more than 40% by mass of grains the diameter of which is less than 45 μm at most and at least 1%, 2%, 5%, 10%, 15%, 20%, 25%, 30%, 35%, 40%, 45%, 50%, 55% or 60% by mass of grains the diameter of which is less than 45 μm at most.

For example, according to an embodiment of the present invention, the oxidized and/or phosphorized copper powder contains not more than 35% by mass of grains the diameter of which is less than 45 μm at most and at least 1%, 2%, 5%, 10%, 15%, 20%, 25%, 30%, 35%, 40%, 45%, 50%, 55%, 60% or 65% by mass of grains the diameter of which is less than 45 μm at most.

For example, according to an embodiment of the present invention, the oxidized and/or phosphorized copper powder contains not more than 30% by mass of grains the diameter of which is less than 45 μm at most and at least 1%, 2%, 5%, 10%, 15%, 20%, 25%, 30%, 35%, 40%, 45%, 50%, 55%, 60%, 65% or 70% by mass of grains the diameter of which is less than 45 μm at most.

For example, according to an embodiment of the present invention, the oxidized and/or phosphorized copper powder contains not more than 25% by mass of grains the diameter of which is less than 45 μm at most and at least 1%, 2%, 5%, 10%, 15%, 20%, 25%, 30%, 35%, 40%, 45%, 50%, 55%, 60%, 65%, 70% or 75% by mass of grains the diameter of which is less than 45 μm at most.

For example, according to an embodiment of the present invention, the oxidized and/or phosphorized copper powder contains not more than 20% by mass of grains the diameter of which is less than 45 μm at most and at least 1%, 2%, 5%, 10%, 15%, 20%, 25%, 30%, 35%, 40%, 45%, 50%, 55%, 60%, 65%, 70%, 75% or 80% by mass of grains the diameter of which is less than 45 μm at most.

For example, according to an embodiment of the present invention, the oxidized and/or phosphorized copper powder contains not more than 15% by mass of grains the diameter of which is less than 45 μm at most and at least 1%, 2%, 5%, 10%, 15%, 20%, 25%, 30%, 35%, 40%, 45%, 50%, 55%, 60%, 65%, 70%, 75%, 80% or 85% by mass of grains the diameter of which is less than 45 μm at most.

For example, according to an embodiment of the present invention, the oxidized and/or phosphorized copper powder contains not more than 10% by mass of grains the diameter of which is less than 45 μm at most and at least 1%, 2%, 5%, 10%, 15%, 20%, 25%, 30%, 35%, 40%, 45%, 50%, 55%, 60%, 65%, 70%, 75%, 80%, 85% or 90% by mass of grains the diameter of which is less than 45 μm at most.

For example, according to an embodiment of the present invention, the oxidized and/or phosphorized copper powder contains not more than 5% by mass of grains the diameter of which is less than 45 μm at most and at least 1%, 2%, 5%, 10%, 15%, 20%, 25%, 30%, 35%, 40%, 45%, 50%, 55%, 60%, 65%, 70%, 75%, 80%, 85%, 90% or 95% by mass of grains the diameter of which is less than 45 μm at most.

For example, according to an embodiment of the present invention, the oxidized and/or phosphorized copper powder contains not more than 2% by mass of grains the diameter of which is less than 45 μm at most and at least 1%, 2%, 5%, 10%, 15%, 20%, 25%, 30%, 35%, 40%, 45%, 50%, 55%, 60%, 65%, 70%, 75%, 80%, 85%, 90%, 95% or 98% by mass of grains the diameter of which is less than 45 μm at most.

For example, according to an embodiment of the present invention, the oxidized and/or phosphorized copper powder contains not more than 1% by mass of grains the diameter of which is less than 45 μm at most and at least 1%, 2%, 5%, 10%, 15%, 20%, 25%, 30%, 35%, 40%, 45%, 50%, 55%, 60%, 65%, 70%, 75%, 80%, 85%, 90%, 95%, 98% or 99% by mass of grains the diameter of which is less than 45 μm at most.

For example, according to an embodiment of the present invention, the oxidized and/or phosphorized copper powder contains not more than 0.5% by mass of grains the diameter of which is less than 45 μm at most and at least 1%, 2%, 5%, 10%, 15%, 20%, 25%, 30%, 35%, 40%, 45%, 50%, 55%, 60%, 65%, 70%, 75%, 80%, 85%, 90%, 95%, 98%, 99% or 99.5% by mass of grains the diameter of which is less than 45 μm at most.

These particular embodiments can be combined individually with the following upper grain size ranges. Indeed, according to an embodiment of the present invention, the powder grains are all less than 500 μm in diameter.

Advantageously, the powder grains are all less than 250 μm in diameter.

More advantageously, the powder grains are all less than 200 μm in diameter.

More advantageously, the powder grains are all less than 150 μm in diameter.

More advantageously, the powder grains are all less than 125 μm in diameter.

More advantageously, the powder grains are all less than 110 μm in diameter.

More advantageously, the powder grains are all less than 100 μm in diameter.

More advantageously, the powder grains are all less than 95 μm in diameter.

More advantageously, the powder grains are all less than 90 μm in diameter.

More advantageously, the powder grains are all less than 85 μm in diameter.

More advantageously, the powder grains are all less than 80 μm in diameter.

More advantageously, the powder grains are all less than 70 μm in diameter.

More advantageously, the powder grains are all less than 65 μm in diameter.

More advantageously, the powder grains are all less than 60 μm in diameter.

Thus, more particularly, the object of the present invention relates to a composition of oxidized and/or phosphorized copper powder as defined above wherein the particle size distribution has the specific features detailed below.

According to a particular embodiment of the invention, the powder contains grains of the following diameters D:
1±1% by mass of grains of diameter D1: 125 μm≤D1
2±2% by mass of grains of diameter D2: 106 μm≤D2<125 μm
12±10% by mass of grains of diameter D3: 75 μm≤D3<106 μm
10±5% by mass of grains of diameter D5: 63 μm≤D5<75 μm
20±10% by mass of grains of diameter D6: 45 μm≤D6<63 μm
40±30% by mass of grains of diameter D7: D7≤45 μm

According to an advantageous embodiment of the invention, the powder contains grains of the following diameters D:
1±1% by mass of grains of diameter D1: 125 μm≤D1
2±2% by mass of grains of diameter D2: 106 μm≤D2<125 μm
5±5% by mass of grains of diameter D3: 90 μm≤D3<106 μm
7±5% by mass of grains of diameter D4: 75 μm≤D3<90 μm
10±5% by mass of grains of diameter D5: 63 μm≤D5<75 μm
20±10% by mass of grains of diameter D6: 45 μm≤D6<63 μm
40±30% by mass of grains of diameter D7: D7≤45 μm

According to an advantageous embodiment of the invention, the powder contains grains of the following diameters D:
1±0.5% by mass of grains of diameter D1: 125 μm≤D1
2±1% by mass of grains of diameter D2: 106 μm≤D2<125 μm
5±2% by mass of grains of diameter D3: 90 μm≤D3<106 μm
7±2% by mass of grains of diameter D4: 75 μm≤D3<90 μm
10±3% by mass of grains of diameter D5: 63 μm≤D5<75 μm
20±5% by mass of grains of diameter D6: 45 μm≤D6<63 μm
50±20% by mass of grains of diameter D7: D7≤45 μm

According to a more advantageous embodiment of the invention, the powder contains grains of the following diameters D:
0.9±0.1% by mass of grains of diameter D1: 125 μm≤D1
1.5±0.5% by mass of grains of diameter D2: 106 μm≤D2<125 μm
4.5±1% by mass of grains of diameter D3: 90 μm≤D3<106 μm
6.5±1% by mass of grains of diameter D4: 75 μm≤D3<90 μm
8.5±1% by mass of grains of diameter D5: 63 μm≤D5<75 μm
18±5% by mass of grains of diameter D6: 45 μm≤D6<63 μm
60±10% by mass of grains of diameter D7: D7≤45 μm

According to a more advantageous embodiment of the invention, the powder contains grains of the following diameters D:
0.9±0.1% by mass of grains of diameter D1: 125 μm≤D1
1.5±0.5% by mass of grains of diameter D2: 106 μm≤D2<125 μm
4.5±1% by mass of grains of diameter D3: 90 μm≤D3<106 μm
6.5±1% by mass of grains of diameter D4: 75 μm≤D3<90 μm
8.5±1% by mass of grains of diameter D5: 63 μm≤D5<75 μm
18±5% by mass of grains of diameter D6: 45 μm≤D6<63 μm
60±5% by mass of grains of diameter D7: D7≤45 μm

According to an even more advantageous embodiment of the invention, the powder contains grains of the following diameters D:
0.9% by mass of grains of diameter D1: 125 μm≤D1
1.5% by mass of grains of diameter D2: 106 μm≤D2<125 μm
4.5% by mass of grains of diameter D3: 90 μm≤D3<106 μm
6.6% by mass of grains of diameter D4: 75 μm≤D3<90 μm
8.4% by mass of grains of diameter D5: 63 μm≤D5<75 μm
20.8% by mass of grains of diameter D6: 45 μm≤D6<63 μm
58.8% by mass of grains of diameter D7: D7≤45 μm

According to an advantageous embodiment of the invention, the powder contains grains of the following diameters D:
1.0% by mass of grains of diameter D2: 106 μm≤D2
8.1% by mass of grains of diameter D3′: 75 μm≤D3′<106 μm
7.9% by mass of grains of diameter D5: 63 μm≤D5<75 μm
19.2% by mass of grains of diameter D6: 45 μm≤D6<63 μm
63.8% by mass of grains of diameter D7: D7≤45 μm

Traditionally, the mass percentages are added to have a cumulative particle size according to the standard ISO 4497. It is easy for the skilled person, in view of the ranges given above, simply to add the values in order to find the current particle size standards (cumulative).

As said before, these particle size values are independent of the chemical nature of the powder, and simply enable the powders to be incorporated into a binder.

With regard to the density of the compositions, it is generally between 1 and 5 g/cm³, more particularly between 1.5 and 3 g/cm³, 1.5 and 2 g/cm³, 2 and 3 g/cm³, 2 and 2.5 g/cm³, 2.5 and 3 g/cm³. The density will depend on both the particle size and the chemical nature of the powder, in particular its degree of oxidation.

The oxidized copper composition according to the present invention is characterized in that the copper is oxidized to various degrees, i.e. , ranging from surface oxidation of the copper grains to oxidation to the core.

Preferably, the oxidized copper composition according to the present invention is characterized in that the copper grains are oxidized to the core.

The oxidized copper composition according to the present invention is characterized in that the copper is oxidized in various proportions: for example, the oxidized copper composition can be oxidized in a proportion of 5%, 10%, 15%, 20%, 25%, 30%, 35%, 40%, 45%, 50%, 55%, 60%, 65%, 70%, 75%, 80%, 85%, 90% or 95% by mass of oxidized copper relative to the total mass of copper.

This degree of oxidation makes it possible to adjust the biocidal activity of the final coating/composite.

According to an embodiment of the present invention, the oxidized copper composition according to the present invention is characterized in that the oxidation ratio of the copper is greater than 95% by mass of oxidized copper relative to the total mass of copper and/or in that the amount of phosphorus is between 2% and 16%, preferably 8% by mass relative to the total mass of powder.

For example, according to an embodiment of the present invention, the oxidized copper composition according to the present invention is characterized in that the oxidation ratio of the copper is 95.5%, 96%, 96.5%, 97%, 97.5%, 98%, 98.5%, 99%, 99.5%, 99.7%, 99.8%, 99.9% or 100% by mass of oxidized copper relative to the total mass of copper.

According to an embodiment of the present invention, the oxidized and/or phosphorized copper composition according to the present invention is characterized in that said composition comprises a metal other than copper or a nonmetallic inorganic compound, which can be in a proportion complementary to the copper. For example, the oxidized copper powder can comprise 75% copper and 25% chromium.

For example, the oxidized and/or phosphorized copper composition according to the present invention can be characterized in that said composition comprises at least one metal other than copper, preferably selected from the group consisting of magnesium, tin, technetium, rhenium, iron, chromium, cobalt, zinc, platinum, cadmium, aluminum, nickel, silver, beryllium, calcium, strontium, preferably magnesium, and/or at least one nonmetallic inorganic compound such as nitrogen, arsenic, sulfur, fluorine, chlorine, bromine, carbon, silicon.

Thus, advantageously, the oxidized and/or phosphorized copper composition according to the present invention can be characterized in that said composition comprises a metal other than copper selected from the group consisting of magnesium, tin, iron, chromium, cobalt, zinc, platinum, aluminum, nickel and silver.

Another object of the present invention relates to a method for manufacturing a composition as defined above, characterized in that the copper is oxidized at a temperature equal to or greater than 500 C in the presence of oxygen and/or a source of oxygen, preferably in the presence of magnesium or phosphorus.

According to an embodiment, the temperature is greater than 800 C, 1000° C., 1500° C. or 2000 C.

Oxygen or a gas containing oxygen can be blown in directly. Generally, this is done in open air. A compound of the powder itself which, when heated, releases oxygen can also be incorporated.

Of course, the copper can be fractionated before being heated in order to enable better oxidation. The copper can nevertheless be oxidized before being fractionated into powder.

Fractionation into powder can be carried out by any technique known in the art, whether by mechanical, chemical or physical fractionation, etc. It is possible to obtain the desired powder according to the present invention directly by adequate fractionation, which involves perfect control of the technique by the operator who, nevertheless, calls upon general knowledge of the art. Moreover, an easier alternative technique is well-known in the art, which consists in fractionating the material coarsely with relatively irregular particle size, followed by successive sieving operations, in order to isolate particular powder populations (i.e., of particular and regular particle size). In the context of the present invention, this technique is quite applicable: A rough fractionation can be carried out, followed by a step of sampling and isolating the particular powders, then a step of selecting the powder in order to reconstitute the powder according to the invention. These techniques are extremely common in the art. Indeed, the control of particle size forms part of the general knowledge of the skilled person. Thus, it is obvious in the context of the present invention that it is possible to add other compounds/powders, such as metal powders, in order to obtain a “mixed” composition, having the technical effects described at present in addition to other effects provided by the secondary compounds/powders added. Thus, an embodiment of the present patent application relates to a method for manufacturing a composition according to the present invention characterized in that the oxidized copper powder is obtained directly by fractionation or is reconstituted from several powders with given particle size and proportions of copper. Advantageously, the powders with given particle size were obtained by any one of the fractionation techniques known in the art, followed by passing at least twice over molecular sieves to ensure that the size of the particles constituting the powder are neither too small nor too large in given amounts, thus ensuring perfect control of the essential features need to carry out the present invention. Moreover, techniques for determining copper content are extremely common in the art and can be carried out by chemical and/or physical means.

Nevertheless, and preferably, fractionation is carried out by an atomization technique, for example with water (following metallic melt). Advantageously, the particles obtained by such techniques are between 8 and 150 μm (D50) and the amount of oxygen comprised in the composition is between 0.3% and 5% by weight. Nevertheless, according to an embodiment of the invention the oxidation of the copper itself can occur after fractionation by passing the composition into the oven under controlled atmosphere.

According to an embodiment of the present invention, the composite of oxidized and/or phosphorized copper powder and binding agent as defined above is characterized in that the binding agent is an organic polymer preferably selected from polyester, polyurethane, an epoxy, vinyl ester polymer or an inorganic polymer preferably selected from silica, polydimethylsiloxanes, polythiazyls, polysilanes, polygermanes, more preferably a silica polymer such as glass.

According to an embodiment of the present invention, the composite of oxidized and/or phosphorized copper powder and binding agent as defined above is characterized in that the proportion by mass of powder to binder in the composition is from 1/2 to 2/1 respectively, preferably 1.275/1 respectively or 1/1.5 respectively, preferably 1/1.5 in the case of vinyl ester resins.

For example, the composite of oxidized and/or phosphorized copper powder and binding agent as defined above is characterized in that the proportion by mass of powder to binder in the composition is from 1.1/1 to 1.5/1 respectively, from 1.15/1 to 1.4/1 respectively, from 1.2/1 to 1.35/1 respectively, from 1.25/1 to 1.3/1 respectively, or is 1.275/1 respectively.

For example, the composite of oxidized and/or phosphorized copper powder and binding agent as defined above is characterized in that the proportion by mass of powder to binder in the composition is from 1/1.1 to 1/1.8 respectively, from 1/1.2 to 1/1.7 respectively, from 1/1.3 to 1/1.6 respectively, from 1/1.4 to 1/1.55 respectively, or is 1/1.5 respectively, preferably in the case of vinyl ester resins.

### FIGURES

FIG. 1: Change in the logarithm of the total number of CFU over time

### EXAMPLES

In order to illustrate the present invention, the following examples were carried out. In no case is the object of the present invention limited to these examples alone.
1. CuP₈-based Powder

CuP₈ powder, the particle size of which is not controlled, is known to be used in brazing.

Traditionally, it has the following features:
Nominal composition (mass %): Cu: 92
P: 8
Point melting: 710-750 C
Density: 8 g/cm³
   Protocol for Manufacturing the Copper-phosphorus Powder according to the Invention

According to the present invention, the copper-phosphorus alloy containing a percentage of phosphorus between 2% and 16%, preferably 8%, is introduced into the melt bath. This alloy is then atomized with water under conditions such that the particle size results must be between 8 and 150 μm (D50); the oxygen content is between 0.3% and 5% by weight.
The following powder was thus obtained:

TABLE 1
Particle size, cumulative % retained (ISO 4497)

| | | |
|---|---|---|
| | Percentages | Cumulative percentages |
| Particle size | by interval | retained |

| | | | |
|---|---|---|---|
| ≥125 | μm | 0.0 | 0.0 |
| ≥106 | μm | 0.9 | 0.9 |
| ≥90 | μm | 4.5 | 5.4 |
| ≥75 | μm | 6.6 | 12.0 |
| ≥63 | μm | 8.4 | 20.4 |
| ≥45 | μm | 20.8 | 41.2 |
| <45 | μm | 58.8 | 58.8 |

| | | |
|---|---|---|
| Total | 100% | 100% |
| | | (41.2 + 58.8) |

Density obtained: 2.67 g/cm³ (ISO 3923/2)
P% obtained: 8.0% by mass
2. Oxidized Copper Powder
The same protocol as for copper-phosphate was applied for copper.

The following powder was thus obtained:

TABLE 2
Particle size, cumulative % retained (ISO 4497)

| | | |
|---|---|---|
| | Percentages | Cumulative percentages |
| Particle size | by interval | retained |

| | | | |
|---|---|---|---|
| ≥125 | μm | 0.0 | 0.0 |
| ≥106 | μm | 1.0 | 1.0 |
| ≥75 | μm | 8.1 | 9.1 |
| ≥63 | μm | 7.9 | 17.0 |
| ≥45 | μm | 19.2 | 36.2 |
| <45 | μm | 63.8 | 63.8 |

| | | |
|---|---|---|
| Total | 100% | 100% |
| | | (36.2 + 63.8) |

Density obtained: 2.88 g/cm³
O_{T}%: 0.35% by mass (ISO 4491-4)
Next, the powder obtained passed into a conveyor oven at a temperature above 500 C (about 800 C in the present case) in order to oxidize it, under controlled atmosphere.
A powder with same particle size as before was obtained with:
density: 1.60 g/cm³
O_{T}%: 0.08% by mass
Cu%>99.7% by mass
3. Example of the Composite/Coatings Obtained

The composites are simply obtained by mixing the compounds together.

The coatings in Table 3 were applied in the following traditional manner.

First, the surface to be treated is sanded (120 grain). In the case of a metal surface, it is possible to apply an insulating anti-corrosion primer suited to the nature of the substrate (ferrous, nonferrous, etc.). In the case of a porous surface (stone, wood, etc.), it is possible to apply a polyester primer in two coats, if need be with roughing (120 grain) between coats.

It is strongly advised to respect the curing times of the polyester primer (about 6 hours at 20 C per coat) so that the thin layer endures over time. Next, the part can undergo active drying with compressed air or by baking at 25 C in an enclosure for 20 minutes. It is possible to degrease the surface to be treated.

It is quite possible to apply the composite by means of a roller or gun (with, in this case, the need to project the composite onto the surface at a constant angle of 90° for maximum coverage).

The coated product can be stored in a room with a controlled atmosphere at 20 C, ideally for 12 hours for effective curing (for a boat this is more difficult to obtain, which is why curing accelerators are used to carry out catalysis at up to 5 C minimum). Once this curing period is over, sanding (120 grain) is carried out in order to strip the surface of excess starch and oxides and to obtain a smooth metal surface.

TABLE 3

| | Composite 1 | Composite 2 | Composite 3 |
|---|---|---|---|
| Metal powder | CuP₈ (powder of | Oxidized copper | Oxidized copper |
| | Example 1) | (powder of | (powder of |
| | | Example 2) | Example 2) |
| Binder | Hybrid polyester 84% | Hybrid polyester 84% | Vinyl ester, ready-to- |
| (proportions | Acetone 8% | Acetone 8% | use, available |
| by mass) | Styrene wax 2% | Styrene wax 2% | commercially |
| | Colorant 4% | Colorant 4% | |
| Curing agent | METHYL ETHYL | METHYL ETHYL | |
| (proportions | PEROXIDE, 2% | PEROXIDE, 2% | |
| by mass) | | | |
| Proportions | Powder = 1.275 | Powder = 1.275 | Powder = 1 |
| by mass of | Binder = 1 | Binder = 1 | Binder = 1.5 |
| powder to | | | (estimated |
| binder | | | value) |
| Suspension | yes | yes | yes |
| possible | | | |
| Coating | By spraying | By spraying | By spraying |
| obtained | (possible with a | (possible with a | (possible with a |
| | roller) | roller) | roller) |
| Curing time | 60 minutes | 60 minutes | 60 minutes |
| Approximate | 100-250 μm | 100-250 μm | 100-250 μm |
| thickness of | (estimated value) | (estimated value) | (estimated value) |
| the coating | | | |
| obtained | | | |

4. Examples of Biocidal Activity

Results of laboratory tests showed that the coatings had remarkable biocidal properties:

TABLE 4
Mean CFU count on MetalSkin medical versus control; Analysis
of raw values (Except treatment/sampling surface)

| | Mean CFU | Mean CFU | % MetalSkin | | |
|---|---|---|---|---|---|
| | count/Control | count/MetalSkin | count/Control | | Mann-Whitney |
| | elements | elements | count | Wilcoxon test | test |
| | (amplitude) | (amplitude) | (amplitude) | (p value) | (p value) |
| Door handle | 6 (0-17) | 0 (0-10) | 0% (0-233) | 0.02524 | 0.00964 |
| (corridor) | | | | | |
| Door handle | 6 (0-18) | 0 (0-9) | 0% (0-300) | 0.00014 | 0.00002 |
| (ward) | | | | | |
| Switch, ward | 8 (0-16) | 0 (0-10) | 0% (0-350) | 0.00008 | 0.00002 |
| entrance | | | | | |
| Shower grab- | 13 (0-44) | 8 (0-25) | 61% (3-300) | 0.00291 | 0.00449 |
| bar | | | | | |
| Toilet lid | 7 (0-31) | 0 (0-12) | 0% (0-1200) | 0.19863 | 0.23713 |
| Faucet handle | 9 (0-20) | 6 (0-18) | 73% (0-480) | 0.00646 | 0.02163 |
| Adjustable tray | 10 (0-21) | 0 (0-10) | 0% (0-450) | 0.00046 | 0.00009 |

Thus, the coatings obtained according to the present invention demonstrate their biocidal (including antimicrobial) properties in various applications, whether in a dry state or in the presence of fluids such as water.
5. Study of a Copper-containing Composite in Reducing Bacterial Carriage of Elements of an Orthopedic Surgery Ward in a Clinic

5.1. Introduction

In France, nosocomial infections are a significant source of morbidity and mortality. Nearly 4200 deaths per year are attributable thereto. The extra expenditures generated by these infections are evaluated between 2.4 and 6 billion euros per year, notably due to longer periods of hospitalization, antibiotic treatment, laboratory tests and infection monitoring.

It is known that about 30% of nosocomial infections could be prevented by suitable hygiene measures, including handwashing. The role of the environment in the infectious process seems proven, at least for certain bacteria. The studies carried out have been most interested in objects frequently touched by the hands, which thus become elements of the spread of infection.

Typical cleanliness measures seem insufficient to ensure this hygiene, even more so as some bacteria remain present for a long time, even after cleaning (in particular in the case of Staphylococcus aureus).

Measures proposed for decreasing bacterial carriage include the use of active products such as hydrogen peroxide, but also the use of antimicrobial materials for the most frequently used surfaces (door handles, toilet lids, taps, switches, etc.). The application on these surfaces of an antimicrobial material can help to reduce these cross-contaminations. One recognized bactericidal product is copper, which, in vitro, kills many microorganisms, including Escherichia coli, methicillin-resistant Staphylococcus aureus, Listeria monocytogenes, influenza A virus and C. difficile. Copper-based products seem to show advantageous results in vitro and studies by Sasahara and Casey demonstrate a significant decrease in bacteria on surfaces treated with copper.

However, the cost of solid copper and the large number of locations or objects to be treated make their generalized use relatively improbable or too costly.

A copper-containing composite according to the present invention was developed for coating handles, taps and another equipment at a lower cost given the small thickness (200 microns) of copper.

The goal of this study is to show the efficacy of this novel product in terms of antibacterial activity within orthopedic surgery wards.

5.2. Methods

5.2.1 Clinical Protocol

The alloy of the product used is copper-phosphorized, with 95% copper. This product was used to coat the objects most frequently used and touched by the hands in wards.

The experiment concerned six rooms of the orthopedic surgery department of the Saint Roch clinic in Montpellier (France). Among these six rooms, three selected randomly were equipped with the copper-containing product. There are seven elements concerned in each treated room: two door handles (exterior, interior), a switch, an adjustable tray, a toilet lid, a shower grip-bar and a shower knob. The other three rooms kept the usual equipment and thus comprised the control group.

The study lasted eight weeks. Samples were taken every Monday, Wednesday, Thursday and Friday in each of the six rooms and on each of the seven elements under study. The total number of samples taken is thus 1344.

For weeks 5 to 8, two rooms were switched around: a treated room became a control and a control room became treated. The diagram of the experimental design is thus as follows:

TABLE 5
Diagram of the experimental design

| | Room | Room | Room | Room | Room | Room |
|---|---|---|---|---|---|---|
| | 1 | 2 | 3 | 4 | 5 | 6 |
| Weeks | Control | Control | Control | Treated | Treated | Treated |
| 1-4 | | | | | | |
| Weeks | Control | Treated | Control | Control | Treated | Treated |
| 5-8 | | | | | | |

5.2.2. Microbiological Methodology and Sampling

The sample is taken on a swab soaked in sterile solution and using a sterile template. Rubbing is carried out 15 times in each direction. Then the swabs are submerged in neutralizing solution, centrifuged and incubated at 37 C for 48 hours. The sampling template is sterile.

Counting and identification are carried out next.

Bacterial count: a single laboratory [. . . ] performed the bacterial count.

The bacterial count was carried out taking into account a positivity threshold. Below 5 CFU per 25 cm² of surface area, the count is considered zero.

In order to standardize the surface areas of the calculation, the latter was set to 100 cm² for all the sampling locations. Thus, the calculations for the door handles and the grab-bar were multiplied by 8 and the other locations multiplied by 4. Indeed, for the toilet lid, the adjustable tray, the switch and the taps the surface area is 25 cm² while for the door handles and the grab bar it is 12.5 cm².

The rooms are cleaned once per day. Cleaning usually takes place between 9 a.m. and 10 a.m. As for the samples, they were all taken after 4 p.m. (generally between 4 p.m. and 5 p.m.). The exact room cleaning schedule was recorded, as was the sampling schedule. As a result, the period of time between cleaning and sampling could be calculated.

5.2.3. Statistical Methods

5.2.3.1. Calculation of the Number of Samples Needed

This calculation was made for each element since the goal is to compare the mean total number of bacteria (bioMérieux identification system) on each sampling site between the control room group and the treated room group. To calculate the number of samples needed, we made the assumption that our results would be close to those obtained in the “Birmingham” study.

In terms of overall mean CFU between the treated rooms and the control rooms in the Birmingham study, for the tops of the toilet lids, one passes from 2190 CFU to 6 on mean, with great variability (in the Birmingham study there were only 200 samples). But these toilet lids were very contaminated.

We thus plan to find a mean of 6 to 15 elements on each site with the controls and from 1 to 8 with the prepared elements. I.e., a minimum mean deviation between 9 and 7, with a standard deviation varying between 2 and 5.

Looking at the mean case (standard deviation=4) leads to:

84 samples on each site (handle, etc.) and per group of rooms (mean deviation=2) and with 10% of the data uninterpretable from 94 samples per group of rooms.

However, per sampling site, we planned 48 samplings the first 4 weeks (per group of rooms) and 48 the following 4 weeks, for a total of 96. Thus the number planned should be enough to answer the question asked, on all the sites.

5.2.3.2. Statistical Analyses

The total number of CFU, all sampling sites taken together, were first compared between the two groups of rooms. Then, the same comparisons were made by sampling site (seven sites).

A comparison of the number of colonies of Staphylococcus aureus (±Micrococcus±Bacillus) between the treated rooms and the control rooms was then carried out, with all the sampling sites first considered together and then considered site by site.

The period of time between cleaning and sampling was also compared between the groups of rooms.

The nonparametric Wilcoxon-Mann-Whitney test (Mann-Whitney U test) was used for all the comparisons.

Weeks 1 to 4 and 5 to 8 were differentiated throughout the analysis (because two rooms switched). For the paired case (over 8 weeks), the results are not presented, the lack of power being too great (only 4 rooms remaining).

Finally, the temporal change in the logarithm of the total number of microorganisms was studied using a mixed model with repeated measures. Indeed, a logarithmic transformation was carried out due to the non-verification of the assumption of normality, needed to carry out the mixed model.

The statistical analyses were all carried out with SAS software 9.3, SAS Institute Inc., Cary, N.C., USA, by the Biostatistics and Epidemiology team EA 2415 of Montpellier University I.

5.3. Results

5.3.1. Weeks 1 to 4

The time between cleaning and sampling was first compared in the two groups of rooms, in order to eliminate this confounding variable. This period does not appear to be statistically different between the groups of rooms, either week by week or over the totality of the first 4 weeks (Table 6). The median period of time varies between 4 and 6 hours.

TABLE 6
Time between cleaning and sampling - Weeks 1 to 4

| | All rooms | | Treatment | | Control | | |
|---|---|---|---|---|---|---|---|
| | (N = 6) | | (N = 3) | | (N = 3) | | p-value |
| Time between cleaning | | | | | | | |
| and sampling Week 1 | | | | | | | |
| Mean (SD) | 5.28 | (1.04) | 5.73 | (0.74) | 4.84 | (1.25) | 0.6625 |
| Median (Min; Max) | 5.48 | (3.86; 6.25) | 6.08 | (4.88; 6.22) | 4.42 | (3.86; 6.25) | |
| Time between cleaning | | | | | | | |
| and sampling Week 2 | | | | | | | |
| Mean (SD) | 4.28 | (0.58) | 4.45 | (0.86) | 4.1 | (0.17) | 1.0000 |
| Median (Min; Max) | 4.04 | (3.9; 5.44) | 4.02 | (3.9; 5.44) | 4.07 | (3.96; 4.29) | |
| Time between cleaning | | | | | | | |
| and sampling Week 3 | | | | | | | |
| Mean (SD) | 4.91 | (0.92) | 5.35 | (0.5) | 4.47 | (1.14) | 0.3827 |
| Median (Min; Max) | 5.11 | (3.19; 5.79) | 5.46 | (4.81; 5.79) | 4.86 | (3.19; 5.35) | |
| Time between cleaning | | | | | | | |
| and sampling Week 4 | | | | | | | |
| Mean (SD) | 4.79 | (0.63) | 4.91 | (0.45) | 4.68 | (0.86) | 1.0000 |
| Median (Min; Max) | 4.96 | (3.71; 5.36) | 4.96 | (4.44; 5.33) | 4.96 | (3.71; 5.36) | |
| Time between cleaning | | | | | | | |
| and sampling Weeks 1-4 | | | | | | | |
| Mean (SD) | 4.82 | (0.52) | 5.11 | (0.56) | 4.52 | (0.34) | 0.3827 |
| Median (Min; Max) | 4.72 | (4.13; 5.6) | 5.22 | (4.51; 5.6) | 4.72 | (4.13; 4.72) | |

Table 7 presents the results in the three treated rooms and the three untreated rooms for weeks 1 to 4 cumulatively. Overall, a trend toward significance (nonparametric test) is noted (p=0.0809) with a mean of 685 bacterial colonies (median=685) in the treated group and 1091 (median=1058) in the untreated group. This trend is due to that noted during the second week; however, for the other weeks, a reduction of almost 50% of the median number of microorganism colonies is found, as well as a reduction of more than 1/3 of the mean value.

TABLE 7
Total number of CFU - Weeks 1 to 4

| | All rooms | | Treatment | | Control | | |
|---|---|---|---|---|---|---|---|
| | (N = 6) | | (N = 3) | | (N = 3) | | p-value |
| Total CFU Week 1 | | | | | | | |
| Mean (SD) | 247.33 | (89.32) | 195.67 | (85) | 299 | (68.64) | 0.3827 |
| Median (Min; Max) | 259.5 | (111; 378) | 195 | (111; 281) | 265 | (254; 378) | |
| Total CFU Week 2 | | | | | | | |
| Mean (SD) | 224.5 | (104.36) | 145.33 | (46) | 303.67 | (79.43) | 0.0809 |
| Median (Min; Max) | 202 | (99; 361) | 146 | (99; 191) | 337 | (213; 361) | |
| Total CFU Week 3 | | | | | | | |
| Mean (SD) | 202.5 | (69.14) | 160.67 | (79.73) | 244.33 | (18.56) | 0.3827 |
| Median (Min; Max) | 235.5 | (105; 262) | 125 | (105; 252) | 246 | (225; 262) | |
| Total CFU Week 4 | | | | | | | |
| Mean (SD) | 214 | (72.47) | 183.33 | (70.12) | 244.67 | (73.42) | 0.3827 |
| Median (Min; Max) | 203.5 | (131; 327) | 156 | (131; 263) | 221 | (186; 327) | |
| Total CFU Weeks 1-4 | | | | | | | |
| Mean (SD) | 888.33 | (228.49) | 685 | (23) | 1091.67 | (77.22) | 0.0809 |
| Median (Min; Max) | 872.5 | (662; 1180) | 685 | (662; 708) | 1058 | (1037; 1180) | |

The total number of CFU over weeks 1 to 4 was then analyzed by sampling site (interior handle, exterior handle, switch, etc.). A trend toward significance is observed for the treated sites for the exterior door handle (p=0.0765), the switch (p=0.0809) and the adjustable tray (p=0.0809) (Table 8). The lack of power explains the non-significance for the interior handle. For the other elements, the values are much lower in the group of treated rooms, but not in an interpretable manner

TABLE 8
Total number of CFU per sampling site - Weeks 1 to 4

| | All rooms | | Treatment | | Control | | |
|---|---|---|---|---|---|---|---|
| | (N = 6) | | (N = 3) | | (N = 3) | | p-value |
| CFU Interior handle | | | | | | | |
| Weeks 1-4 | | | | | | | |
| Mean (SD) | 62.33 | (36.96) | 36.33 | (12.1) | 88.33 | (35.23) | 0.1904 |
| Median (Min; Max) | 49.5 | (27; 117) | 32 | (27; 50) | 99 | (49; 117) | |
| CFU Exterior handle | | | | | | | |
| Weeks 1-4 | | | | | | | |
| Mean (SD) | 87.33 | (30.27) | 60.33 | (10.12) | 114.33 | (1.15) | 0.0765 |
| Median (Min; Max) | 92.5 | (54; 115) | 55 | (54; 72) | 115 | (113; 115) | |
| CFU Switch Weeks 1-4 | | | | | | | |
| Mean (SD) | 70.17 | (31.17) | 48 | (26.46) | 92.33 | (15.95) | 0.0809 |
| Median (Min; Max) | 73.5 | (18; 110) | 58 | (18; 68) | 88 | (79; 110) | |
| CFU Tray Weeks 1-4 | | | | | | | |
| Mean (SD) | 134 | (67.04) | 85.67 | (30.27) | 182.33 | (57.55) | 0.0809 |
| Median (Min; Max) | 126 | (58; 246) | 81 | (58; 118) | 167 | (134; 246) | |
| CFU Toilet Weeks 1-4 | | | | | | | |
| Mean (SD) | 118 | (37.14) | 116.33 | (11.37) | 119.67 | (57.54) | 1.0000 |
| Median (Min; Max) | 117.5 | (61; 176) | 113 | (107; 129) | 122 | (61; 176) | |
| CFU Shower Weeks 1-4 | | | | | | | |
| Mean (SD) | 251.33 | (91.37) | 200 | (49.76) | 302.67 | (102.42) | 0.3827 |
| Median (Min; Max) | 227 | (146; 410) | 210 | (146; 244) | 292 | (206; 410) | |
| CFU Tap Weeks 1-4 | | | | | | | |
| Mean (SD) | 165.17 | (48.35) | 138.33 | (37.1) | 192 | (48.03) | 0.3827 |
| Median (Min; Max) | 158.5 | (98; 239) | 146 | (98; 171) | 194 | (143; 239) | |

The number of colonies of Staphylococcus aureus (±Micrococcus±Bacillus) was studied more particularly.

Concerning the total colony count, the only trends toward significance (although the count is still much lower in the treated versus untreated rooms) relate to the totality of weeks 1 to 4 (p=0.0765, mean of 424 versus 782 and median of 470 versus 783) and week 3 (p=0.0809, median of 108 for the treated rooms versus 196 for the untreated rooms, or mean of 110 for the treated rooms versus 199 for the untreated rooms) (Table 9).

TABLE 9
Number of colonies of Staphylococcus aureus (±Micrococcus ± Bacillus) - Weeks 1 to 4

| | All rooms | | Treatment | | Control | | |
|---|---|---|---|---|---|---|---|
| | (N = 6) | | (N = 3) | | (N = 3) | | p-value |
| Total Staph Week 1 | | | | | | | |
| Mean (SD) | 175.5 | (61.59) | 142.67 | (69.28) | 208.33 | (38.08) | 0.3827 |
| Median (Min; Max) | 186.5 | (67; 252) | 158 | (67; 203) | 191 | (182; 252) | |
| Total Staph Week 2 | | | | | | | |
| Mean (SD) | 156.5 | (90.52) | 101.33 | (57.36) | 211.67 | (89.8) | 0.1904 |
| Median (Min; Max) | 156.5 | (61; 314) | 76 | (61; 167) | 175 | (146; 314) | |
| Total Staph Week 3 | | | | | | | |
| Mean (SD) | 154.67 | (55.42) | 110 | (40.04) | 199.33 | (9.45) | 0.0809 |
| Median (Min; Max) | 171.5 | (71; 210) | 108 | (71; 151) | 196 | (192; 210) | |
| Total Staph Week 4 | | | | | | | |
| Mean (SD) | 116 | (71.17) | 69.67 | (38.37) | 162.33 | (68.92) | 0.1904 |
| Median (Min; Max) | 92 | (26; 220) | 85 | (26; 98) | 181 | (86; 220) | |
| Total Staph Weeks 1-4 | | | | | | | |
| Mean (SD) | 602.67 | (203.07) | 423.67 | (80.25) | 781.67 | (23.03) | 0.0765 |
| Median (Min; Max) | 614 | (331; 804) | 470 | (331; 470) | 783 | (758; 804) | |

When the number of colonies of Staphylococcus aureus (±Micrococcus±Bacillus) is compared by sampling site, a trend toward significance is noted for the exterior handle (p=0.0809), the switch (p=0.0809), the adjustable tray (p=0.0809) and the tap (p=0.0809) (Table 10). The values for these locations are substantially lower on the treated sites. For the other locations, the values are always lower on the treated sites but are not significant due to lack of power.

TABLE 10
Number of colonies of Staphylococcus aureus (±Micrococcus
± Bacillus) by sampling site - Weeks 1 to 4

| | All rooms | | Treatment | | Control | | |
|---|---|---|---|---|---|---|---|
| | (N = 6) | | (N = 3) | | (N = 3) | | p-value |
| Staph Interior handle | | | | | | | |
| Weeks 1-4 | | | | | | | |
| Mean (SD) | 40.17 | (26.89) | 23.33 | (10.97) | 57 | (28.93) | 0.1840 |
| Median (Min; Max) | 30 | (17; 78) | 17 | (17; 36) | 69 | (24; 78) | |
| Staph Exterior handle | | | | | | | |
| Weeks 1-4 | | | | | | | |
| Mean (SD) | 64.67 | (26.63) | 41.67 | (8.96) | 87.67 | (10.26) | 0.0809 |
| Median (Min; Max) | 65.5 | (36; 99) | 37 | (36; 52) | 85 | (79; 99) | |
| Staph Switch Weeks 1-4 | | | | | | | |
| Mean (SD) | 43.17 | (24.81) | 23 | (14.73) | 63.33 | (10.07) | 0.0809 |
| Median (Min; Max) | 47 | (14; 74) | 15 | (14; 40) | 62 | (54; 74) | |
| Staph Tray Weeks 1-4 | | | | | | | |
| Mean (SD) | 90.33 | (64.67) | 37 | (17.78) | 143.67 | (40.07) | 0.0809 |
| Median (Min; Max) | 85 | (23; 189) | 31 | (23; 57) | 129 | (113; 189) | |
| Staph Toilet Weeks 1-4 | | | | | | | |
| Mean (SD) | 74.83 | (38.04) | 57.33 | (21.78) | 92.33 | (47.17) | 0.3827 |
| Median (Min; Max) | 69.5 | (33; 137) | 64 | (33; 75) | 97 | (43; 137) | |
| Staph Shower Weeks 1-4 | | | | | | | |
| Mean (SD) | 169 | (48.53) | 144 | (38.74) | 194 | (50.12) | 0.3827 |
| Median (Min; Max) | 166 | (100; 242) | 159 | (100; 173) | 198 | (142; 242) | |
| Staph Tap Weeks 1-4 | | | | | | | |
| Mean (SD) | 120.5 | (32.69) | 97.33 | (10.26) | 143.67 | (30.92) | 0.0809 |
| Median (Min; Max) | 112 | (86; 178) | 100 | (86; 106) | 135 | (118; 178) | |

5.3.2. Weeks 5 to 8

The same analyses were repeated for weeks 5 to 8.

The periods of time between cleaning and sampling are all mostly not significant, either week by week or over the last four weeks in total (median of 4.93 hours for the treated rooms versus 4.77 hours for the untreated rooms) (Table 11).

TABLE 11
Period of time between cleaning and sampling - Weeks 1 to 4

| | All rooms | | Treatment | | Control | | |
|---|---|---|---|---|---|---|---|
| | (N = 6) | | (N = 3) | | (N = 3) | | p-value |
| Time between cleaning | | | | | | | |
| and sampling Week 5 | | | | | | | |
| Mean (SD) | 4.9 | (0.46) | 5.06 | (0.33) | 4.74 | (0.58) | 0.6625 |
| Median (Min; Max) | 4.91 | (4.38; 5.42) | 5.1 | (4.71; 5.35) | 4.44 | (4.38; 5.42) | |
| Time between cleaning | | | | | | | |
| and sampling Week 6 | | | | | | | |
| Mean (SD) | 4.71 | (0.42) | 4.67 | (0.06) | 4.75 | (0.66) | 0.6625 |
| Median (Min; Max) | 4.71 | (4; 5.24) | 4.69 | (4.6; 4.73) | 5 | (4; 5.24) | |
| Time between cleaning | | | | | | | |
| and sampling Week 7 | | | | | | | |
| Mean (SD) | 5.26 | (0.72) | 5.15 | (0.58) | 5.38 | (0.95) | 1.0000 |
| Median (Min; Max) | 4.86 | (4.73; 6.48) | 4.89 | (4.73; 5.81) | 4.83 | (4.82; 6.48) | |
| Time between cleaning | | | | | | | |
| and sampling Week 8 | | | | | | | |
| Mean (SD) | 4.64 | (0.49) | 4.84 | (0.1) | 4.44 | (0.69) | 0.6625 |
| Median (Min; Max) | 4.79 | (3.65; 4.96) | 4.79 | (4.77; 4.96) | 4.79 | (3.65; 4.89) | |
| Time between cleaning | | | | | | | |
| and sampling Weeks 5-8 | | | | | | | |
| Mean (SD) | 4.88 | (0.41) | 4.93 | (0.12) | 4.83 | (0.63) | 0.6625 |
| Median (Min; Max) | 4.87 | (4.23; 5.48) | 4.93 | (4.81; 5.05) | 4.77 | (4.23; 5.48) | |

For the total number of microorganism colonies, the comparison between groups shows a trend toward significance for week 8, and overall for weeks 5 to 8 taken together (=0.0809). The treated rooms have a median of 571 colonies versus 1056 for the control rooms (Table 12).

TABLE 12
Total number of CFU - Weeks 5 to 8

| | All rooms | | Treatment | | Control | | |
|---|---|---|---|---|---|---|---|
| | (N = 6) | | (N = 3) | | (N = 3) | | p-value |
| Total CFU Week 5 | | | | | | | |
| Mean (SD) | 252.33 | (151.12) | 164.67 | (87.23) | 340 | (162.56) | 0.1904 |
| Median (Min; Max) | 234 | (74; 525) | 172 | (74; 248) | 275 | (220; 525) | |
| Total CFU Week 6 | | | | | | | |
| Mean (SD) | 178.33 | (59.92) | 148.33 | (33.95) | 208.33 | (71.58) | 0.1904 |
| Median (Min; Max) | 165 | (118; 286) | 142 | (118; 185) | 194 | (145; 286) | |
| Total CFU Week 7 | | | | | | | |
| Mean (SD) | 221.83 | (112.4) | 160.33 | (68.63) | 283.33 | (124.62) | 0.3827 |
| Median (Min; Max) | 199 | (83; 366) | 184 | (83; 214) | 344 | (140; 366) | |
| Total CFU Week 8 | | | | | | | |
| Mean (SD) | 152.33 | (66.79) | 94 | (16.37) | 210.67 | (26.03) | 0.0809 |
| Median (Min; Max) | 146 | (76; 236) | 98 | (76; 108) | 212 | (184; 236) | |
| Total CFU Weeks 5-8 | | | | | | | |
| Mean (SD) | 804.83 | (264.04) | 567.33 | (60.58) | 1042.33 | (37.42) | 0.0809 |
| Median (Min; Max) | 813 | (505; 1071) | 571 | (505; 626) | 1056 | (1000; 1071) | |

By sampling site, a trend toward significance in favor of the treated sites is noted for the interior handle (p=0.0809), the switch (p=0.0809), the toilet lid (p=0.0809) and the shower grab-bar (p=0.0765) (Table 13). In all the cases, the mean and median numbers of microorganism colonies are much lower in the treated sites, the lack of power explaining the non-significance.

TABLE 13
Total number of CFU per sampling site - Weeks 5 to 8

| | All rooms | | Treatment | | Control | | |
|---|---|---|---|---|---|---|---|
| | (N = 6) | | (N = 3) | | (N = 3) | | p-value |
| CFU Interior handle | | | | | | | |
| Weeks 5-8 | | | | | | | |
| Mean (SD) | 90.33 | (50.73) | 45 | (14) | 135.67 | (8.5) | 0.0809 |
| Median (Min; Max) | 94 | (35; 144) | 39 | (35; 61) | 136 | (127; 144) | |
| CFU Exterior handle | | | | | | | |
| Weeks 5-8 | | | | | | | |
| Mean (SD) | 92.83 | (27.72) | 74.67 | (25.7) | 111 | (16.46) | 0.2683 |
| Median (Min; Max) | 101.5 | (51; 130) | 71 | (51; 102) | 102 | (101; 130) | |
| CFU Switch Weeks 5-8 | | | | | | | |
| Mean (SD) | 119 | (56.72) | 78.67 | (32.15) | 159.33 | (46.14) | 0.0809 |
| Median (Min; Max) | 114 | (42; 212) | 92 | (42; 102) | 140 | (126; 212) | |
| CFU Tray Weeks 5-8 | | | | | | | |
| Mean (SD) | 135.83 | (59.45) | 99.33 | (32.81) | 172.33 | (61.34) | 0.1904 |
| Median (Min; Max) | 121.5 | (77; 227) | 84 | (77; 137) | 184 | (106; 227) | |
| CFU Toilet Weeks 5-8 | | | | | | | |
| Mean (SD) | 74 | (35.95) | 45 | (18.08) | 103 | (19.52) | 0.0809 |
| Median (Min; Max) | 72.5 | (26; 122) | 47 | (26; 62) | 104 | (83; 122) | |
| CFU Shower Weeks 5-8 | | | | | | | |
| Mean (SD) | 174.33 | (51.11) | 128.33 | (2.31) | 220.33 | (13.32) | 0.0765 |
| Median (Min; Max) | 170 | (127; 235) | 127 | (127; 131) | 217 | (209; 235) | |
| CFU Tap Weeks 5-8 | | | | | | | |
| Mean (SD) | 126.67 | (60.66) | 97.33 | (10.12) | 156 | (80.72) | 0.6625 |
| Median (Min; Max) | 100.5 | (66; 222) | 92 | (91; 109) | 180 | (66; 222) | |

Concerning the number of colonies of Staphylococcus aureus (±Micrococcus±Bacillus), a trend toward significance is noted for week 8 (p=0.0765) and for the totality of weeks 5 to 8 (p=0.0809), with the treated rooms having about half the number of colonies (median of 433 for the treated rooms and 849 for the control rooms) (Table 14).

TABLE 14
Number of colonies of Staphylococcus aureus (±Micrococcus ± Bacillus) - Weeks 5 to 8

| | All rooms | | Treatment | | Control | | |
|---|---|---|---|---|---|---|---|
| | (N = 6) | | (N = 3) | | (N = 3) | | p-value |
| Total Staph Week 5 | | | | | | | |
| Mean (SD) | 197.67 | (134.32) | 127.67 | (75.37) | 267.67 | (157.24) | 0.3827 |
| Median (Min; Max) | 177 | (57; 449) | 119 | (57; 207) | 185 | (169; 449) | |
| Total Staph Week 6 | | | | | | | |
| Mean (SD) | 125.83 | (51.62) | 103 | (26.85) | 148.67 | (66.16) | 0.3827 |
| Median (Min; Max) | 117.5 | (74; 212) | 108 | (74; 127) | 154 | (80; 212) | |
| Total Staph Week 7 | | | | | | | |
| Mean (SD) | 188.83 | (96.09) | 135.33 | (65.25) | 242.33 | (101.19) | 0.3827 |
| Median (Min; Max) | 171 | (64; 310) | 150 | (64; 192) | 291 | (126; 310) | |
| Total Staph Week 8 | | | | | | | |
| Mean (SD) | 98.83 | (50.6) | 54 | (5.2) | 143.67 | (18.56) | 0.0765 |
| Median (Min; Max) | 91.5 | (48; 163) | 57 | (48; 57) | 142 | (126; 163) | |
| Total Staph Weeks 5-8 | | | | | | | |
| Mean (SD) | 611.17 | (220.42) | 420 | (66.46) | 802.33 | (86.08) | 0.0809 |
| Median (Min; Max) | 591 | (348; 855) | 433 | (348; 479) | 849 | (703; 855) | |

When the number of colonies of Staphylococcus aureus (±Micrococcus±Bacillus) is compared by sampling site, a trend toward significance is noted for the interior handle (p=0.0809), the switch (p=0.0809), the toilet lid (p=0.0809) and the shower grab-bar (p=0.0809) (Table 15). The values for these locations are substantially lower on the treated site. For the other locations, there is also a large decrease in terms of the treated sites versus the untreated sites but the difference does not appear to be significant due to lack of power.

TABLE 15
Number of colonies of Staphylococcus aureus (±Micrococcus
± Bacillus) by sampling site - Weeks 5 to 8

| | All rooms | | Treatment | | Control | | |
|---|---|---|---|---|---|---|---|
| | (N = 6) | | (N = 3) | | (N = 3) | | p-value |
| Staph Interior handle | | | | | | | |
| Weeks 5-8 | | | | | | | |
| Mean (SD) | 63.83 | (41.73) | 29 | (11.53) | 98.67 | (24.11) | 0.0809 |
| Median (Min; Max) | 57 | (16; 124) | 33 | (16; 38) | 96 | (76; 124) | |
| Staph Exterior handle | | | | | | | |
| Weeks 5-8 | | | | | | | |
| Mean (SD) | 67 | (25.22) | 50.33 | (18.23) | 83.67 | (20.6) | 0.1904 |
| Median (Min; Max) | 69 | (34; 107) | 47 | (34; 70) | 76 | (68; 107) | |
| Staph Switch Weeks 5-8 | | | | | | | |
| Mean (SD) | 97.67 | (48.63) | 68.33 | (32.13) | 127 | (47.95) | 0.0809 |
| Median (Min; Max) | 93.5 | (32; 182) | 80 | (32; 93) | 105 | (94; 182) | |
| Staph Tray Weeks 5-8 | | | | | | | |
| Mean (SD) | 103.5 | (42.66) | 83.67 | (37.42) | 123.33 | (44.38) | 0.1904 |
| Median (Min; Max) | 100 | (55; 160) | 70 | (55; 126) | 136 | (74; 160) | |
| Staph Toilet Weeks 5-8 | | | | | | | |
| Mean (SD) | 57.33 | (38.89) | 29.67 | (15.28) | 85 | (35.37) | 0.0809 |
| Median (Min; Max) | 44.5 | (13; 115) | 33 | (13; 43) | 94 | (46; 115) | |
| Staph Shower Weeks 5-8 | | | | | | | |
| Mean (SD) | 127.5 | (42.7) | 90.33 | (18.56) | 164.67 | (8.39) | 0.0809 |
| Median (Min; Max) | 131.5 | (71; 170) | 92 | (71; 108) | 169 | (155; 170) | |
| Staph Tap Weeks 5-8 | | | | | | | |
| Mean (SD) | 94.33 | (54.54) | 68.67 | (16.04) | 120 | (72.13) | 0.6625 |
| Median (Min; Max) | 77 | (43; 186) | 70 | (52; 84) | 131 | (43; 186) | |

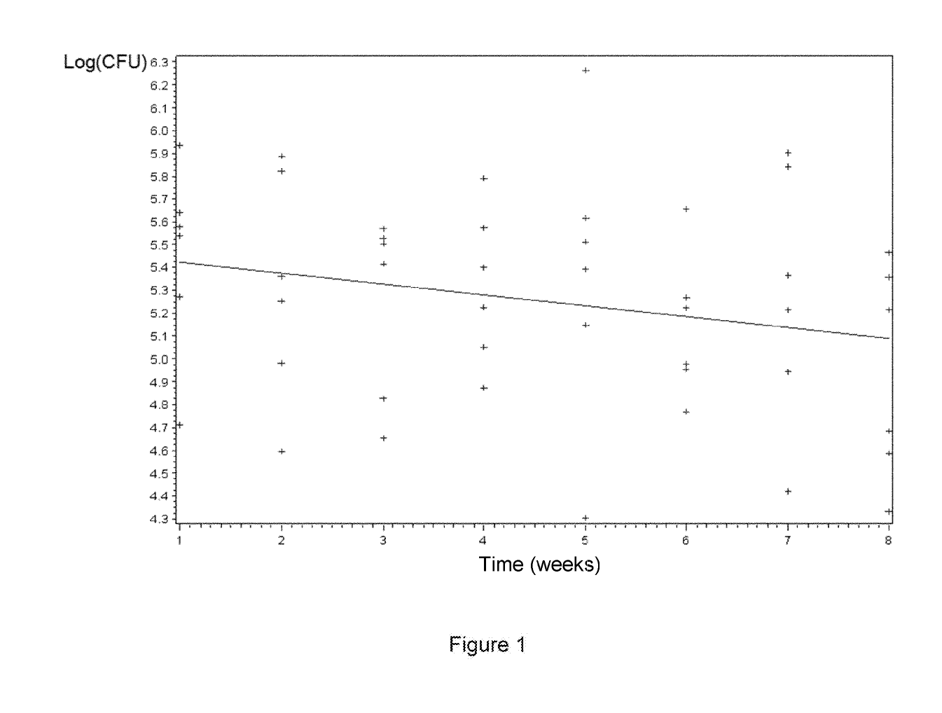

Lastly, the analysis of the temporal change in the logarithm of the total number of microorganisms in the six rooms involved in the experiment shows a clear trend (p=0.07) toward decrease during the 8 weeks (Table 16, FIG. 1).

TABLE 16
Mixed model with repeated measures of the natural
logarithm of the total number of CFU

| Effect | Estimate | Standard error | df | t value | Pr > \|t\| |
|---|---|---|---|---|---|
| time | −0.04761 | 0.02569 | 41 | −1.85 | 0.0710 |

FIG. 1 shows the change in the logarithm of the total number of CFU over time.

5.4. Discussion and Conclusion

The study by Noyce et al. (Appl Environ Microbiol 2006; 72:4239-4244) is experimental on three strains of Staphylococcus aureus. On copper-coated surfaces, at 22° C., these three strains are killed in 45, 60 and 90 minutes, respectively. On stainless steel-coated surfaces, at 22° C. and after 72 hours, living colonies are found for the three Staphylococcus aureus strains. The authors also find that, at 4° C., the microbial colonies are completely destroyed after 6 hours.

By using the method of Noyce, Wheeldon et al. (Appl Environ Microbiol 2007; 73:2748-2750; J Antimicrob Chemother 2008; 62:522-525) comparing the effect of a preparation of copper to that of stainless steel on contamination by Clostridium difficile NCTC 11204 and Clostridium difficile 027 R20291. Stainless steel does not show antimicrobial activity against vegetative C. difficile after 30 minutes of exposure (no reduction of activity at 3 hours). On the other hand, copper has antimicrobial activity (p<0.05) against vegetative C. difficile as of 60 minutes after exposure. At 3 hours, with copper, there is a decrease of 99.79% and 99.87% in the logarithm of germinating spores of C. difficile NCTC 11204 and 027 R20291, respectively.

Casey et al. (J Hosp Infect (2009), doi:10.1016/j.jhin.2009.08.018), by means of a crossover study of the elements of an acute-care ward, compared the number of microorganisms between the elements containing copper and those containing none. After 5 weeks, the elements containing copper and those containing none were interchanged (samples taken once per week at two different hours: 7 a.m. and 5 p.m.). The median values of the number of microorganisms harbored on the copper-containing elements are between 50% and 100% lower than the median values observed in the control group, at 7 a.m. as at 5 p.m. The differences are significant except for one location.

The 19-room crossover study carried out by Karpanen et al. (Infect. Control Hosp. Epidemiol. 2012; 33:3-9) involved 14 sites in an acute-care ward. The study lasted 24 weeks, with 12 weeks using copper-containing products (more copper 58%) and then 12 weeks without using copper. The number of aerobic microbes and the presence of microorganism indicators were studied. For eight elements out of 14, the authors found significantly fewer microorganisms on the copper-containing products (compared to the products without copper). For the six other elements, the copper-containing products had reduced numbers, but the result was not statistically significant.

The results that we obtained are in line with those found in the literature, with a lower total number of bacterial colonies for the copper-containing elements. However, we note only a trend toward significance of the decrease in the number of bacteria (this due to a lack of power).

It is important to note that the ratio of copper present in the proposed alloy is very high (thus comparable to that of other proposed products); the difference is in the thickness of the preparation (200 microns), much thinner than for other products. Consequently, considering the lower cost of this product compared to other copper-containing products, a cost directly related to the total amount of copper (and thus not only to the percentage), and due to the fact that the decrease in the microorganism counts is close to that obtained with larger amounts of copper (similar concentrations), we believe that the proposed product provides a genuine advantage in reducing bacterial carriage and transmission in acute-care wards.

Lastly, the analysis of the temporal change in the total number of microorganisms within the six rooms leads us to believe that the copper-phosphorized compound used, by decreasing the number of microorganisms in the rooms under study, reduces the contamination of other unprotected rooms.

1-17. (canceled)

18. A composite characterized in that it comprises
a powder composition of oxidized and/or phosphorized copper powder wherein said powder:
contains at least 60% by mass of copper,
contains not more than 70% by mass of grains the diameter of which is less than 45 μm at most, and
a binding agent.

19. The composite according to claim 18, characterized in that the phosphorized copper powder is in the form of CuP₈.

20. The composite according to claim 18, characterized in that the composite further comprises a curing catalyst.

21. The composite according to claim 18, characterized in that the copper is oxidized to the core.

22. The composite according to claim 18, characterized in that the oxidation ratio of the copper is greater than 95% by mass of oxidized copper relative to the total mass of copper and/or in that the amount of phosphorus is between 2% and 16% by mass relative to the total mass of powder.

23. The composite according to claim 22, characterized in that the amount of phosphorus is 8% by mass relative to the total mass of powder.

24. The composite according to claim 18, characterized in that said composite comprises:
at least one metal other than copper, and/or
at least one nonmetallic inorganic compound.

25. The composite according to claim 24, characterized in that the metal is selected from the group consisting of magnesium, tin, technetium, rhenium, iron, chromium, cobalt, zinc, platinum, cadmium, aluminum, nickel, silver, beryllium, calcium, and strontium.

26. The composite according to claim 25, characterized in that the metal is magnesium.

27. The composite according to claim 24, characterized in that the nonmetallic inorganic compound is selected from the group consisting of nitrogen, arsenic, sulfur, fluorine, chlorine, bromine, carbon and silicon.

28. The composite according to claim 18, characterized in that the binding agent is an organic polymer selected from the group consisting of polyester, polyurethane, an epoxy, and vinyl ester polymer.

29. The composite according to claim 18, characterized in that the binding agent is an inorganic polymer selected from the group consisting of silica, polydimethylsiloxanes, polythiazyls, polysilanes, and polygermanes.

30. The composite according to claim 29, characterized in that the inorganic polymer is a silica polymer.

31. The composite according to claim 30, characterized in that the silica polymer is a glass.

32. The composite according to claim 18, characterized in that the proportion by mass of powder to binder in the composite is from 1/2 to 2/1, respectively.

33. The composite according to claim 32, characterized in that the proportion by mass of powder to binder in the composite is 1.275/1, respectively.

34. A method for preventing nosocomial diseases comprising the use of the composite according to claim 18 as a biocide.
